(19) United States
(12) Patent Application Publication
(10) Pub. No.: US 2008/0089095 A1
(43) Pub. Date: Apr. 17, 2008

(54) Optical Film for Use in a Backlight Module and Said Backlight Module

(75) Inventor: Chih-Liang Pan, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORP., Hsinchu (TW)

(21) Appl. No.: 11/683,156

(22) Filed: Mar. 7, 2007

(30) Foreign Application Priority Data
Oct. 17, 2006 (TW) 95138269

(51) Int. Cl. F21V 7/04; G02B 5/30

(52) U.S. Cl. 362/622; 359/485

(57) ABSTRACT

An optical film for use in a backlight module and the backlight module are disclosed. The backlight module comprises a light source, a light guide plate and a plurality of optical films, wherein the light source is used to provide incident light which will be received by the light guide plate. The light guide plate is used to guide the incident light to the optical films uniformly, and the optical films are disposed above the light guide plate to receive and treat the incident light from the light guide plate. The optical films have at least one substrate having a single-oriented axis, thereby when the optical films rotate 360 degrees along a normal axis thereof, the substrate is adapted to substantially present at least one repetitive distribution of polarization for every 180 degrees, with respect to the incident light emitted from the light source of the backlight module.

This application claims priority to Taiwan Patent Application No. 095138269 filed on Oct. 17, 2006, the disclosures of which are incorporated herein by reference in their entirety.

### CROSS-REFERENCES TO RELATED APPLICATIONS

Not applicable.

### BACKGROUND OF THE INVENTION

1. Field of the Invention

The present invention relates to a backlight module for use in a display apparatus, specifically to an optical film for use in a backlight module.

2. Descriptions of the Related Art

Referring to FIG. 1, a prior side-edge backlight module 10 mainly comprises a light source 11, a light guide plate 12, a reflector 13, and an optical film. The optical film mainly comprises a prism sheet 14 and a diffuser sheet 15, wherein the light source 11 is disposed onto a side of the backside module 10. After incident light enters the light guide plate 12, the light is emitted to the optical film via a reflection of the reflector 13. The module is suitable, but not limited to, a slim display panel, such as the panel used in a notebook computer, a cellular phone, a personal digital assistant, or a panel carried within a vehicle. The light source adopted by the above-mentioned backlight module mainly comprises a cold cathode fluorescent lamp (CCFL) and a light emitting diode (LED), which features high brightness and long life.

The light guide plate 12 which is commonly used, comprises a wedge body which has a continuous V-shaped grooves with different thicknesses for two sides thereof. The light source 11 is disposed on the thicker side of the light guide plate 12 to receive the incident light from the light source 11 and guide the incident light uniformly to increase the amount of outward refraction of the incident light as much as possible. Consequently, the luminance of the panel is enhanced and the brightness uniformity thereof is attained.

In the structure of the above-mentioned backlight module, the light emitted from the light guide plate appears as partially polarized light due to a prism surface and the surface processing of the light guide plate. Furthermore, the prism sheet and the diffuser sheet comprise a substrate which essentially consists of a layer of poly ethylene terephthalate (PET) drawn by biaxial extension. The biaxial extension process causes the substrate to comprise double oriented axis which are perpendicular with each other. When the surface of an optical film rotates 360 degrees along a normal axis, the double-oriented axis causes the substrate to generate a repetitive distribution of polarization in every 90 degrees (i.e., 90, 180, 270 and 360 degrees) with respect to the incident light. In order to enhance the light transmission rate of an LCD panel, it is essential to arrange the polarization direction of the light guide plate and the direction of the oriented axis of the optical film so that they respond well to each other.

However, the PET optical film made by the current biaxial extension process may have different angles of the double oriented light axes on each portion of the substrate such that the optical film cut from various positions of the PET substrate may have oriented axes with various directions. As such, it is difficult to produce a desired match regarding the direction of the polarized light between the optical film having inferior uniformity of the oriented axes, and the light guide plate. Consequently, the light transmission of the panel is reduced.

Recently, techniques for solving the problem of angle variation of the light axes on the PET substrate include selecting and cutting a specific and local portion (i.e. within a scope where the oriented axis thereon is uniform, predictable and controllable) of the PET substrate to solve the problem of angle variation of light axes. However, this solution has accompanying problems, such as an increased amount of waste materials, higher cost for materials, and difficulties selecting the specific portion. Consequently, providing an optical film and a backlight module to maintain or enhance the light transmission of the panel while reducing manufacturing and material costs thereof is an urgent issue for the industry.

### SUMMARY OF THE INVENTION

The primary objective of this invention is to provide an optical film for use in a backlight module. The backlight module comprises a light source adapted to provide incident light to the module. The optical film comprises a substrate with a single-oriented axis, so that when the optical film rotates 360 degrees along a normal axis thereof, the substrate is adapted to substantially present at least one repetitive distribution of polarization for in every 180 degrees (i.e., 180 and 360 degrees), with respect to the incident light.

Another objective of this invention is to provide a backlight module comprising a light source, a light guide plate and a plurality of optical films, wherein the light source is adapted to provide incident light to be received by the light guide plate. The light guide plate can guide the incident light toward the optical films uniformly. The optical films disposed above the light guide plate receive and handle the incident light emitted from the light guide plate. The optical films have at least one substrate with a single-oriented axis, thereby when the optical films rotate 360 degrees along a normal axis thereof, the substrate is adapted to substantially present at least one repetitive distribution of polarization for every other 180 degrees, with respect to the incident light.

The detailed technology and preferred embodiments implemented for the subject invention are described in the following paragraphs accompanying the appended drawings for those skilled in this field to well appreciate the features of the claimed invention.

### BRIEF DESCRIPTION OF THE DRAWINGS

FIG. 1 is a diagram of the backlight module of the prior art;

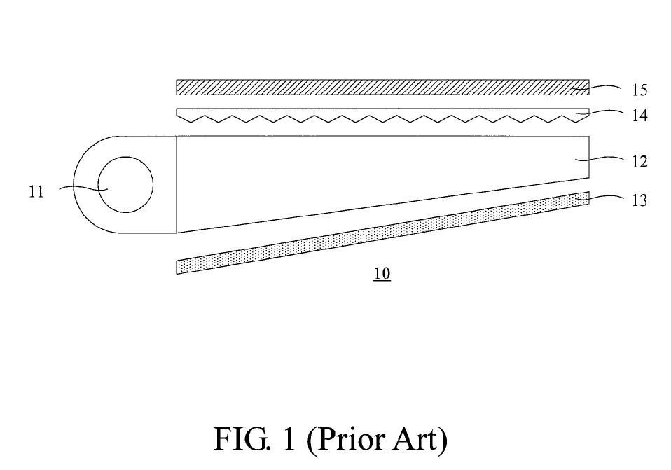

FIG. 2 is a diagram of the backlight module of the first, the second and the third embodiment of the invention;

FIG. 3 is a diagram of the relationship between the light guide plate and the light source of the invention; and

FIG. 4 is a diagram of the backlight module of the fourth embodiment of the invention.

### DESCRIPTION OF THE PREFERRED EMBODIMENT

The invention provides an optical film and a backlight module for use in a liquid crystal display. For convenience, the backlight module in the following descriptions only mentions components related to the invention, but does not limit the components which may be implemented in the invention.

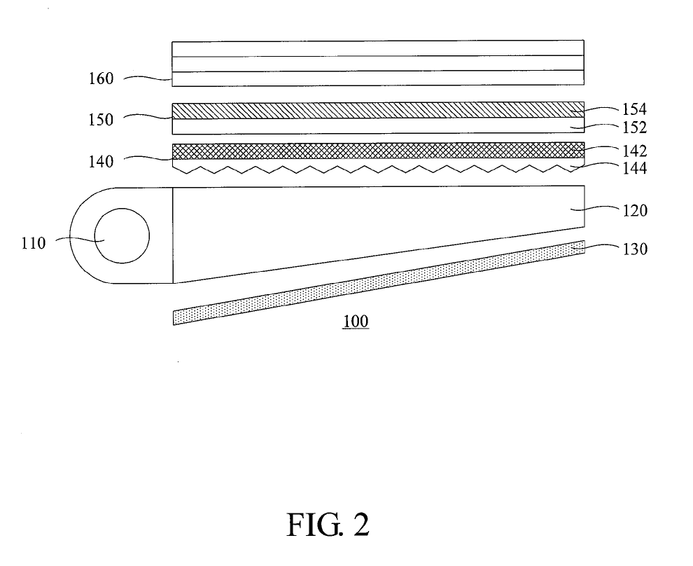

FIG. 2 reveals a backlight module and optical films for use in the backlight module of a first embodiment of the invention. The backlight module 100 comprises a light source 110, a light guide plate 120 and a plurality of optical films, wherein the light source 110 is used to provide an incident light. In real applications of the invention, a cold cathode fluorescent lamp, a light emitting diode or other suitable luminaries can be options for the light source 110.

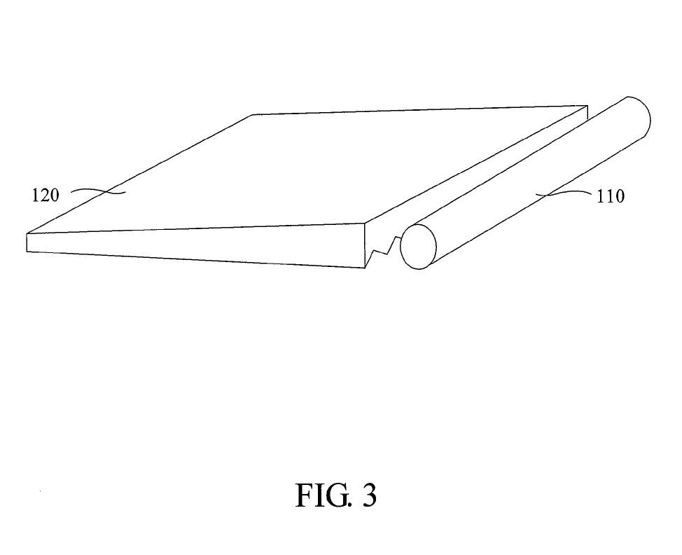

Next, the light guide plate 120 is used to receive the incident light from the light source 110 and guide the incident light uniformly. In this embodiment, the light guide plate 120 has no substantial difference with the one mentioned in the prior art. The light guide plate 120 comprises a wedge body which has continuous V-shaped grooves, disposed on a top or bottom surface thereof, with different thicknesses at the two ends. The light source 11 is disposed adjacent to the thicker end of the light guide plate 120 and the grooves of the V-shaped grooves are exactly opposite to the light source 110 as shown in FIG. 3.

Referring to FIG. 2, the backlight module 100 further comprises a reflector 130 used to reflect the light emitted from a bottom surface of the light plate guide 120 back to the light guide plate 120 to enhance the light source's efficiency.

In this embodiment, the optical films comprise a prism sheet 140 and a diffuser sheet 150 which are respectively disposed on the top surface of the light guide plate 120 for receiving and handling the light emitting from the light guide plate 120. The optical films comprise at least one substrate with a single-oriented axis. Thus, when the optical films rotate 360 degrees along a normal axis thereof, the substrate is adapted to substantially present at least one repetitive distribution of polarization for every 180 degrees (i.e., 180 and 360 degrees), with respect to the incident light.

Specifically, the prism sheet 140 comprises a substrate 142 and a groovy prism array 144, wherein the substrate 142 comprises a single-oriented axis (this is an intrinsic feature possessed by the material and thus it is not shown in the figure) and the groovy prism array 144 is disposed onto the bottom surface of the substrate 142. The substrate 142 having the single-oriented axis is made of an optical plastic material which is, but not limited to, polycarbonate (PC). Additionally, the diffuser sheet 150 is disposed on the top surface of the prism sheet 140 and comprises a substrate 152 and a diffusing particle layer 154, wherein the diffusing particle layer 154 is disposed on the top surface of the substrate 152 and the substrate 152 is the same as, or similar to, the substrate with a double-oriented axis which comprises a layer consisting essentially of, for example, but not limited to, PET as used in the prior art.

It is noted that the optical films of the embodiment of this invention comprise a substrate with a single-oriented axis, which is fabricated by an extension or extrusion molding process in a single direction. Consequently, the substrate only comprises a single-oriented axis. While the optical films rotate 360 degrees along a normal axis thereof, the substrate is adapted to present a repetitive distribution of polarization for every 180 degrees. Compared to the substrate which is made by the biaxial extension process of the prior art, the substrate of the subject invention can substantially reduce the possibility of insufficient light transmission or poor uniformity of the display, which results from the angle variation of the oriented axes between substrates. More specifically, because the substrate is manufactured by an extension process in a single direction, the oriented angles for each portion thereof do not have a substantial difference. Consequently, a substrate with a uniform oriented angle is provided for use in the optical films, which solves the current problems and reduces the costs for manufacturing and materials.

While applying the backlight module in a liquid crystal display, a glass plate 160 used in the panel is disposed on the optical films. In a real embodiment, the glass plate 160 can be a lower polarizer which comprises a transmittance axis. In a preferred embodiment, the single-oriented axis on the optical films and the transmittance axis form an angle smaller than 30 degrees. More preferably, the angle is smaller than 22.5 degrees such that a higher light transmission rate can be obtained between the backlight module and the glass plate of the panel to enhance the luminance of the panel.

The above-mentioned embodiment is only one of several embodiments of the invention. In real applications, there are several possible variations. Using the following second embodiment as an example, the optical film of the above-mentioned embodiment may be changed slightly. Specifically, the difference between the second embodiment and the first embodiment is that a PC substrate with a single-oriented axis is adopted in the substrate 152 of the diffuser sheet 150 and a conventional PET substrate obtained by a biaxial extension process is adopted in the substrate 142 of the prism sheet 10. As mentioned above, the same effect analogous to the previous embodiment can be provided because a substrate with a single-oriented axis is adopted in the diffuser sheet of the plurality of optical films in this embodiment.

Similarly, a different method of utilizing the backlight module of the third embodiment of the invention requires that each optical film adopt a substrate with a single-oriented axis. More specifically, the embodiment individually applies the material of the substrate with a single-oriented axis to the substrate 142 of the prism sheet 140 and the substrate 152 of the diffuser sheet 150 to achieve, or surpass, the same objective.

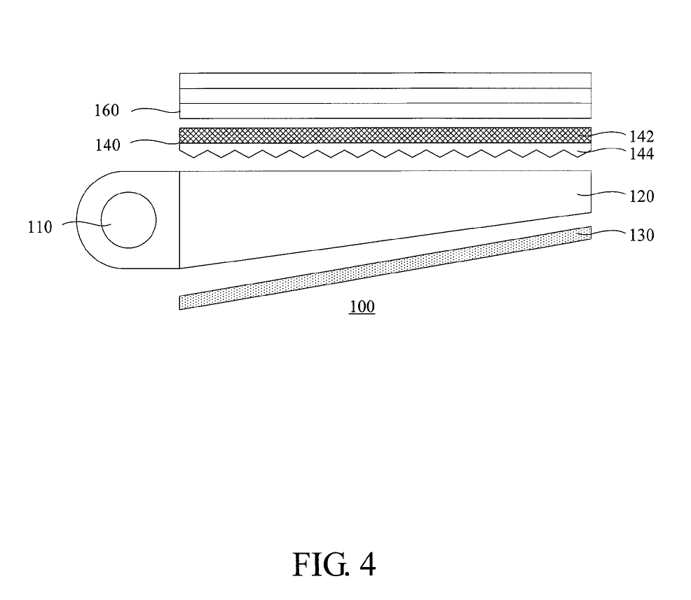

FIG. 4 shows a fourth embodiment of the invention. This embodiment is another application of the invention which removes the diffuser sheet 150 of the first embodiment and only the substrate 142 with a single-oriented axis remains.

The above disclosure is related to the detailed technical contents and inventive features thereof. Those skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A backlight module, comprising:
a light source, adapted to provide an incident light;
a light guide plate, adapted to receive the incident light from the light source and guide the incident light outward uniformly; and
a plurality of optical films, disposed above the light guide plate to receive and handle the incident light emitting from the light guide plate,
wherein the optical films have at least one substrate having a single-oriented axis, thereby when the optical films rotate 360 degrees along a normal axis thereof, the substrate is adapted to substantially present at least one repetitive distribution of polarization in every other 180 degrees, in view of the incident light.

2. The backlight module of claim 1, wherein the plurality of the optical films further comprises:
a groovy prism array, disposed on a bottom surface of the at least one substrate to form a prism sheet; and
a diffuser sheet, disposed above the prism sheet and having a diffusing particle layer.

3. The backlight module of claim 1, wherein the plurality of the optical films further comprises:
a prism sheet, having a groovy prism array; and
a diffusing particle layer, disposed on a top surface of the at least one substrate to form a diffuser sheet, in which the diffuser sheet is disposed above the prism sheet.

4. The backlight module of claim 1, wherein the at least one substrate has a first substrate and a second substrate, and the plurality of the optical films further comprises:
a groovy prism array, disposed on a bottom surface of the first substrate to form a prism sheet; and
a diffusing particle layer, disposed on a top surface of the second substrate to form a diffuser sheet, in which the diffuser sheet is disposed above the prism sheet.

5. The backlight module of claim 1, wherein the plurality of the optical films further comprises a groovy prism array, disposed on a bottom surface of the at least one substrate to form a prism sheet.

6. The backlight module of claim 1, wherein the at least one substrate is made of an optical plastic material.

7. The backlight module of claim 6, wherein the optical plastic material comprises polycarbonate (PC).

8. The backlight module of claim 1, wherein the light guide plate comprises a wedge body, and a plurality of continuous V-shaped grooves which are disposed on a top or bottom surface of the wedge body.

9. The backlight module of claim 1, further comprising a glass plate disposed above the plurality of the optical films, and the glass plate has a transmittance axis, wherein the single-oriented axis and the transmittance axis forms an angle smaller than 30 degrees.

10. The backlight module of claim 9, wherein the angle between the single-oriented axis and the penetrating axis is smaller than 22.5 degrees.

11. An optical film for use in a backlight module, the backlight module comprising a light source which is adapted to provide an incident light, the optical film comprising a substrate, having a single-oriented axis thereby when the optical films rotate 360 degrees along a normal axis thereof, the substrate is adapted to substantially present at least one repetitive distribution of polarization in every other 180 degrees, in view of the incident light.

12. The optical film of claim 11, wherein the backlight module comprises a light guide plate, adapted to receive the incident light emitting from the light source and guide the incident light outward uniformly to be received by the optical film.

13. The optical film of claim 12, wherein the light guide plate comprises a wedge body, and a plurality of continuous V-shaped grooves which are disposed on a top or bottom surface of the wedge body.

14. The optical film of claim 11, wherein the optical films further comprises a prism sheet, which has a groovy prism array disposed on a bottom surface of the substrate.

15. The optical film of claim 11, wherein the optical films further comprises a diffuser sheet, which has a diffusing particle layer disposed on a top surface of the substrate.

16. The optical film of claim 11, wherein the at least one substrate is made of an optical plastic material.

17. The optical film of claim 16, wherein the optical plastic material comprises polycarbonate.

18. The optical film of claim 11, further comprising a glass plate which is disposed above the plurality of the optical films, and the glass plate has a transmittance axis, wherein the single-oriented axis and the transmittance axis forms an angle smaller than 30 degrees.

19. The optical film of claim 18, wherein the angle between the single-oriented axis and the transmittance axis is smaller than 22.5 degrees.
